(19) United States
(12) Patent Application Publication
(10) Pub. No.: US 2017/0212798 A1
(43) Pub. Date: Jul. 27, 2017

(54) LADDER PROGRAM DISPLAY DEVICE HAVING AUTOMATIC TRACE FUNCTION FOR SELF-HOLDING CIRCUIT OF LADDER PROGRAM

(71) Applicant: FANUC Corporation, Yamanashi (JP)

(72) Inventor: Wataru SATOU, Yamanashi (JP)

(21) Appl. No.: 15/414,790

(22) Filed: Jan. 25, 2017

(30) Foreign Application Priority Data
Jan. 26, 2016 (JP) 2016-012314

(51) Int. Cl. G06F 11/07; G06F 11/32; G06F 11/34; G06F 11/30

(52) U.S. Cl. CPC G06F 11/0736; G06F 11/0751; G06F 11/079; G06F 11/302; G06F 11/3055; G06F 11/324; G06F 11/3471; G06F 2201/865

(57) ABSTRACT

A ladder program display device displays an operation status of a ladder program executed by a sequence controller, in which a self-holding circuit is extracted from the ladder program, a signal address used in the extracted self-holding circuit is set as a signal address to be traced, and the display of a result of tracing the signal address by the sequence controller is outputted.

### BACKGROUND OF THE INVENTION

1. Field of the Invention

The present invention relates to a ladder program display device and particularly concerns a ladder program display device having an automatic trace function for a self-holding circuit of a ladder program.

2. Description of the Related Art

In the event of an unintended phenomenon, that is, a malfunction when a user operates a programmable controller, the cause of the malfunction is generally determined by a trace function of confirming a change of a signal having caused the malfunction and a change of an associated signal.

The trace function is the function of recording signal statuses on a time-series basis and displaying the recording results. A method using the trace function is disclosed in Japanese Patent Application Laid-Open No. 07-160312 in which a contact affecting a specified coil is automatically located and is set to be traced.

For ladder programs, many self-holding circuits configured as shown in FIG. 7 are used to hold signal statuses. If such a self-holding circuit starts/finishes holding of a signal status at an improper time, a malfunction may occur in a device to be controlled.

For example, in the example of the self-holding circuit shown in FIG. 7, R0.0 is turned on when X0.0 is turned on. The on state of R0.0 is held even after X0.0 is turned off. Subsequently, R0.0 is turned off when X1.0 is turned on. A feature of the self-holding circuit is that a signal set for a coil is used at any contact on the same net.

In an actual ladder program, self-holding is controlled to be started/finished depending on the combined conditions of several signals. If the self-holding circuit does not normally operate, many combinations of signal statuses need to be examined. The signal statuses are examined by the steps below. In the case of an intermittent malfunction, in particular, it takes quite a long time to determine the cause of the malfunction.
Step 1: Identify a failed self-holding circuit on a ladder program
Step 2: Set the signals of contacts and coils, which are used in the circuit of step 1, as signals to be traced
Step 3: Perform a trace function and record a signal change under normal conditions
Step 4: Perform the trace function again, and then replicate a malfunction to record a signal change
Step 5: Compare the signal changes of step 3 and step 4 to determine the cause of the malfunction

The technique disclosed in Japanese Patent Application Laid-Open No. 07-160312 can simplify step 2 but cannot identify the self-holding circuit in step 1

### SUMMARY OF THE INVENTION

An object of the present invention is to provide a ladder program display device that has the function of reducing the debugging operation of a ladder program under abnormal conditions by automatically detecting a self-holding circuit and automatically tracing associated signals all the time.

The ladder program display device according to the present invention displays an operation status of the ladder program executed by a sequence controller, the ladder program display device including: a self-holding circuit extracting unit that identifies and extracts a self-holding circuit from circuits included in the ladder program, based on the signal addresses of inputs and outputs included in the circuits; a tracing target setting unit that sets, as a signal address to be traced, a signal address used in the self-holding circuit extracted by the self-holding circuit extracting unit; and a tracing result display unit that outputs display of a result of tracing the signal address, set by the tracing target setting unit as the signal address to be traced, by means of the sequence controller.

The self-holding circuit extracting unit may identify, as the self-holding circuit, the circuit including the input and output of the same signal address.

The ladder program display device further includes a tracing result storage unit that stores a result of tracing by means of the sequence controller, wherein the tracing result display unit may compare a past tracing result stored in the tracing result storage unit with a current tracing result so as to detect a difference between the past tracing result and the current tracing result and identify a signal address where the difference between the past tracing result and the current tracing result is detected.

The tracing result display unit may highlight the signal address where the difference is detected, allowing recognition of the signal address where the difference between the past tracing result and the current tracing result is detected.

The tracing result display unit may display a comparison between the past tracing result and the current tracing result, allowing recognition of the signal address where the difference between the past tracing result and the current tracing result is detected.

Signal addresses to be traced may be selectable from the addresses which are set by the tracing target setting unit.

According to the present invention, the self-holding circuit is automatically extracted and thus a user does not have to analyze the ladder program to search for the self-holding circuit. Moreover, a signal associated with the self-holding circuit is automatically set as a signal to be traced and thus a user does not need to set tracing, achieving an efficient debugging operation for the ladder program.

Furthermore, signals set to be traced are traced all the time, allowing examination of the cause of an abnormality with reference to the tracing results without replicating the abnormality. Additionally, a difference between a normal case and an abnormal case is displayed so as to easily identify the cause of an abnormality.

### BRIEF DESCRIPTION OF THE DRAWINGS

FIG. 1 is a schematic block diagram showing a ladder program display device according to an embodiment of the present invention;

FIG. 2 is a functional block diagram showing the ladder program display device according to the embodiment of the present invention;

FIG. 3 shows a structural diagram showing an operating panel where the cause of a malfunction needs to be identified;

FIG. 4 shows an example of a ladder program that controls the operating panel shown in FIG. 3;

FIG. 5 shows a display example of the tracing results of the ladder program shown in FIG. 4;

FIG. 6 is a flowchart showing the flow of extracting a self-holding circuit on the ladder program display device shown in FIG. 2; and

FIG. 7 shows an example of a ladder program including a typical self-holding circuit.

### DETAILED DESCRIPTION OF THE PREFERRED EMBODIMENTS

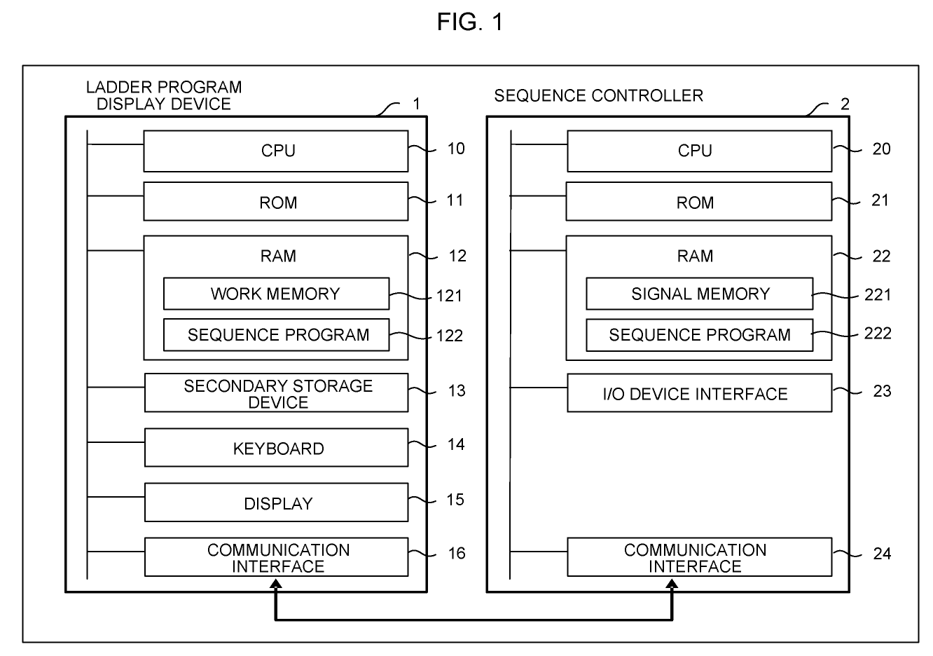

FIG. 1 is a schematic block diagram showing a ladder program display device according to an embodiment of the present invention.

A ladder program display device 1 of the present embodiment includes a CPU 10, a ROM 11, a RAM 12, a secondary storage device 13, a keyboard 14, a display 15, and a communication interface 16.

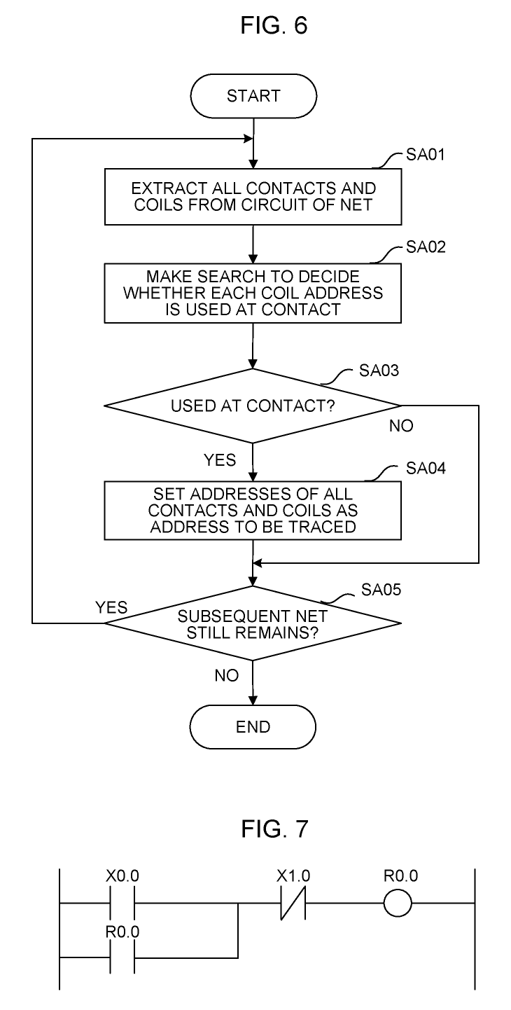

The CPU 10 included in the ladder program display device 1 is a processor that controls the overall ladder program display device 1. The CPU 10 reads a system program stored in the ROM 11 through a bus and controls the ladder program display device 1 according to the system program. The system program includes a program for extracting a self-holding circuit from a sequence program and a program for setting a signal address as a signal to be traced in the self-holding circuit. The system program is executed to perform functions which will be discussed below and processing illustrated in the flowchart of FIG. 6.

The RAM 12 includes a work memory area 121 that stores temporary calculation data, display data displayed on the display 15, and various kinds of data inputted through an input device, e.g., the keyboard 14, and a program storage area 122 that stores program data on sequence programs such as a ladder program to be edited. Moreover, the RAM 12 includes an area for storing temporary data used at the time of execution of a program having the function of extracting the self-holding circuit and a program having a trace function according to the present invention.

The secondary storage device 13 is composed of a nonvolatile storage device, e.g., a hard disk, a memory card, and a USB memory, and a battery-backup nonvolatile memory. The secondary storage device 13 stores sequence programs such as a ladder program handled by the ladder program display device 1 and various files including a configuration file and a parameter file.

The keyboard 14 is an input device that receives an input from a user. The keyboard 14 is used to provide an instruction to perform the function of extracting the self-holding circuit and the trace function. The display 15 is a liquid crystal display device or a touch panel for displaying an internal state of the ladder program display device 1, a sequence program, and tracing results.

The communication interface 16 is connected to networks such as a LAN and a WAN. Sequence programs such as a ladder program are transmitted and received to and from a sequence controller 2 through the communication interface 16.

The sequence controller 2 includes a CPU 20, a ROM 21, a RAM 22, an I/O device interface 23, and a communication interface 24.

The CPU 20 is a processor that plays a leading role in controlling the overall sequence controller 2. Upon power-up of the sequence controller 2, the CPU 20 reads a system program stored in the ROM 21 through a bus and controls the overall sequence controller 2 according to the system program. The system program also includes a program for tracing a signal change. The RAM 22 includes a signal memory 221 that indicates a state of a machine signal address and a program storage area 222 that stores sequence programs such as a ladder program to be executed by the CPU 20.

The sequence controller 2 outputs an output signal from the sequence controller 2 to a machine or a peripheral device (not shown) through the I/O device interface 23 according to the sequence programs stored in the program storage area 222 of the RAM 22. The sequence controller 2 also receives input signals such as a signal from a machine (not shown) or the operating switch of an operating panel provided on the machine and a signal from a sensor device or a peripheral device through the I/O device interface 23. The sequence controller 2 performs necessary processing according to the sequence programs stored in the program storage area 222 and stores the processing results in the signal memory 221.

The sequence controller 2 transmits data on a state of execution of the sequence programs including a signal address state indicated by the signal memory 221, and the sequence controller 2 transmits and receives the sequence programs stored in the program storage area 222 to and from the ladder program display device 1 through the communication interface 24.

With this configuration, the ladder program display device 1 can obtain the sequence programs stored in the program storage area 222 of the sequence controller 2 and display the programs on the display 15. The ladder program display device 1 can also provide display based on data indicating the execution states of the sequence programs, transmit an execution command of the sequence program to the sequence controller 2 from the ladder program display device 1, and store the sequence programs, which have been edited on the program display device 1, in the program storage area 222.

The ladder program display device 1 of the present embodiment includes, for example, a sequence program monitoring device that monitors the operation of the sequence program and a sequence program editor having the function of editing the sequence program. The function of the ladder program display device 1 may be included in the sequence controller 2.

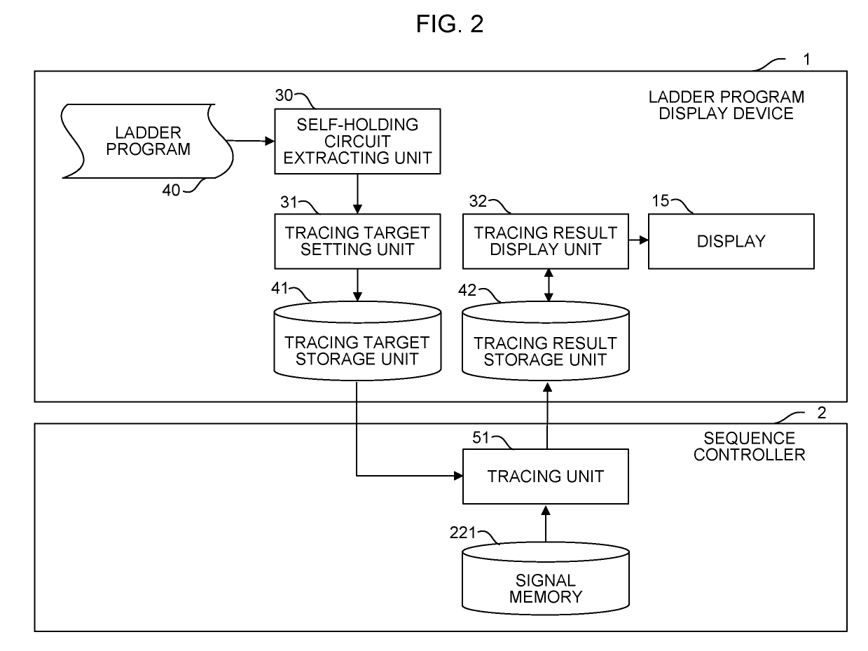

FIG. 2 is a functional block diagram showing the ladder program display device 1 of the present embodiment.

The ladder program display device 1 includes a self-holding circuit extracting unit 30, a tracing target setting unit 31, and a tracing result display unit 32 as functional means.

The self-holding circuit extracting unit 30 automatically extracts all self-holding circuits from circuits included in a ladder program 40 stored in the program storage area 122. As described above, a feature of the self-holding circuit is that a signal set for a coil (output to a signal address) is used at any contact (input from the signal address) on the same net. Thus, a circuit having such a feature is extracted as a self-holding circuit by the self-holding circuit extracting unit 30.

The tracing target setting unit 31 stores the signal addresses of all contacts and coils as tracing targets in a tracing target storage unit 41 provided on the RAM 12 and the like, the contacts and coils being used in the self-holding circuits extracted by the self-holding circuit extracting unit 30.

A tracing unit 51 included in the sequence controller 2 traces the signal memory 221 in response to a tracing start command from a user. The tracing unit 51 extracts, from the signal memory 221, a state of the signal address stored as a tracing target in the tracing target storage unit 41, and then outputs the state of the signal address to a tracing result storage unit 42. In the tracing result storage unit 42, a past tracing result on the signal memory 221 can be stored in addition to a current tracing result. Subsequently, this allows the tracing result display unit 32 to display a comparison between the current tracing result on the signal memory 221 and the past tracing result on the signal memory 221. For example, a tracing result under normal conditions is stored as a past tracing result in the tracing result storage unit 42, allowing detection of an abnormal signal change in comparison between a current signal tracing result and the tracing result under the normal conditions. Two or more past tracing results on the signal memory 221 may be stored depending on, for example, the capacity of the RAM 12.

The tracing result display unit 32 generates a display screen for the tracing results based on the tracing results stored in the tracing result storage unit 42 by the tracing unit 51, and then the tracing result display unit 32 displays the tracing results on the display 15. The current tracing result stored in the tracing result storage unit 42 may be displayed, for example, as a change of a signal status on a time-series basis for each signal address by the tracing result display unit 32. Alternatively, the tracing result display unit 32 may compare a tracing result stored for a current signal address in the tracing result storage unit 42 and a tracing result on a past signal address, and then the tracing result display unit 32 may generate a tracing result display screen based on the comparison result. In the display of tracing results, a difference between a current tracing result and a past tracing result may be distinctly displayed (highlighted with a color change or a blink) or a simple comparison between a past tracing result and a current tracing result may be displayed to show a difference to a user.

In the following example, the cause of a malfunction of an operating panel is identified using the ladder program display device 1 of the present embodiment.

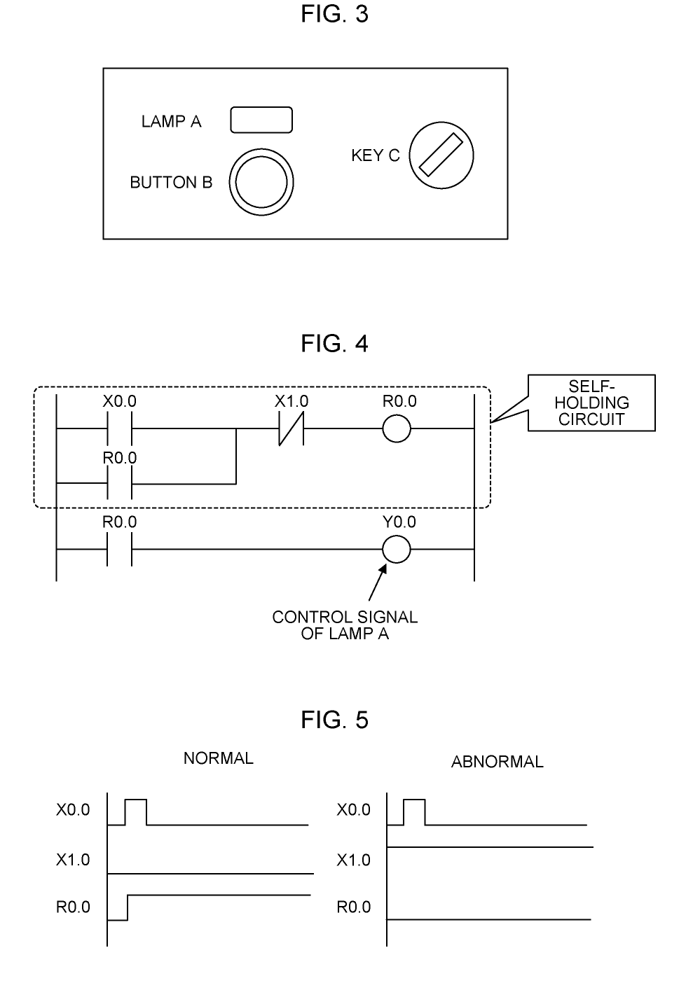

FIG. 3 shows the structure of the operating panel where the cause of a malfunction needs to be identified according to the present embodiment.

In this example, the operating panel having a lamp A, a button B, and a key C is provided on an apparatus.

It is assumed that a designer intended to design the ladder program 40 such that the lamp A illuminates in response to a press on the button B when the key C is turned on. Moreover, it is assumed that the lamp A did not illuminate even when the button B was pressed during an operation of the ladder program 40 (abnormal phenomenon). The cause of the phenomenon is identified by the following steps:

### (System Processing at the Startup of a Ladder)

Step 1: The self-holding circuit extracting unit 30 automatically searches the ladder program 40 at the startup of the ladder to extract all the self-holding circuits. Internal processing for detecting the self-holding circuits is described in a flowchart as will be discussed later (FIG. 6). In this case, the lamp A is controlled by a circuit shown in FIG. 4. The lamp A (signal address Y0.0) is controlled by a coil R (signal address R0.0). In a net surrounded by a dotted line in FIG. 4, a coil R is turned on when the button B (signal address X0.0) is turned on. The on state is then kept by the coil R. Thus, the net surrounded by the dotted line in FIG. 4 is to be extracted as a self-holding circuit.
Step 2: Subsequently, a signal address used as an input signal and an output signal is set as a tracing target by the tracing target setting unit 31 in the net extracted in step 1. From the self-holding circuits of step 1, X0.0, X1.0, and R0.0 are set as signals to be traced.
Step 3: After the completion of step 2, the tracing unit 51 starts tracing the signal addresses set in step 2.
   (Processing under Abnormal Conditions)
Step 4: If the lamp A does not operate in an abnormal phenomenon, the tracing result display unit 32 compares the waveforms of signals traced under previous normal conditions and the waveforms of signals traced under abnormal conditions, thereby detecting the abnormal phenomenon.
Step 5: FIG. 5 shows an example of a comparison between the tracing results of the ladder program in FIG. 4 under normal and abnormal conditions. In this example (on the right in FIGS. 5), X1.0 and R0.0 have different waveforms from the previous result (on the left in FIG. 5). Thus, it is decided that X1.0 and R0.0 are likely to have caused an abnormality. In response to the decision result, a user may confirm the structure of the net including X1.0 and examine the cause of the abnormality. In this case, R0.0 is excluded because R0.0 is a signal for directly controlling the lamp A. In this example, the on state of X0.0 does not turn on R0.0 unless X1.0 is turned off. As in the decision of the ladder program display device 1, X1.0 is found to be the cause of the abnormality.

In the absence of a normal sample or if an abnormality is not found after a comparison, tracing results under abnormal conditions may be stored in the tracing result storage unit 42 in response to a user instruction, and then the user may confirm signals having abnormal waveforms with reference to the stored tracing results.

As described above, the self-holding circuits prone to cause abnormality are automatically traced, and then the tracing results are automatically compared with each other under subsequent abnormal conditions, allowing the user to easily examine the cause of an abnormality. Furthermore, the traced results can be confirmed beforehand, thereby reducing a debugging operation without the need for trace setting and reproduction of the phenomenon.

FIG. 6 is a flowchart showing the flow of processing performed by the self-holding circuit extracting unit 30 and the tracing target setting unit 31. The description will be given in line with each step of the flowchart.

[Step SA01] The self-holding circuit extracting unit 30 extracts a net from the ladder program 40 and then extracts all contacts and coils from the circuit of the extracted net.
[Step SA02] The self-holding circuit extracting unit 30 searches for the addresses of the coils to decide whether each of the addresses is used at any one of the contacts extracted in step SA01.
[Step SA03] Based on the search results in step SA02, the self-holding circuit extracting unit 30 decides whether the signal address of any one of the coils is used at any one of the contacts in the circuit of the same net. If the signal address is used at any one of the contacts, the processing proceeds to step SA04. Otherwise the processing proceeds to step SA05.
[Step SA04] The tracing target setting unit 31 stores the signal addresses of all the contacts and coils extracted in step SA02, as tracing targets in the tracing target storage unit 41.
[Step SA05] The self-holding circuit extracting unit 30 decides whether a subsequent net still remains in the ladder program 40. If a subsequent net still remains, the processing proceeds to step SA01. Otherwise the processing ends.

The embodiment of the present invention was described above. The present invention is not limited only to the foregoing embodiment and can be properly changed to be implemented in various forms.

For example, in the foregoing embodiment, the self-holding circuit extracting unit 30 automatically extracts the self-holding circuits from the ladder program 40, and then the tracing target setting unit 31 sets the signal addresses of contacts and coils, which are included in the extracted self-holding circuits, as signal addresses to be traced. For signals automatically set to be traced, another means may be provided to allow a user to narrow the signals to be traced.

Moreover, tracing results may be displayed for each of the self-holding circuits by the tracing result display unit 32.

Thus, a user can confirm circuits to be confirmed and signal addresses in an organized manner, thereby performing an efficient debugging operation.

In the foregoing embodiment, as shown in FIG. 2, the tracing target storage unit 41 and the tracing result storage unit 42 are provided in the ladder program display device 1. The tracing target storage unit 41 and the tracing result storage unit 42 may be provided on the sequence controller 2.

As a result of a real-time comparison between a current tracing result and a past tracing result in the tracing unit 51, a warning may be released if a different signal status is detected. In this case, a comparison result between a current tracing result and a past tracing result in the tracing unit 51 is outputted to the tracing result display unit 32 directly or through the tracing result storage unit 42. The tracing result display unit 32 may display the comparison result between the current tracing result and the past tracing result after receiving the comparison result from the tracing unit 51.

1. A ladder program display device that displays an operation status of a ladder program executed by a sequence controller, the ladder program display device comprising:
a self-holding circuit extracting unit that identifies and extracts a self-holding circuit from circuits included in the ladder program, based on signal addresses of inputs and outputs included in the circuits;
a tracing target setting unit that sets, as a signal address to be traced, a signal address used in the self-holding circuit extracted by the self-holding circuit extracting unit; and
a tracing result display unit that outputs display of a result of tracing the signal address, set by the tracing target setting unit as the signal address to be traced, by means of the sequence controller.

2. The ladder program display device according to claim 1, wherein the self-holding circuit extracting unit identifies, as the self-holding circuit, the circuit including an input and an output of the same signal address.

3. The ladder program display device according to claim 1, further comprising a tracing result storage unit that stores a result of tracing by means of the sequence controller,
wherein the tracing result display unit compares a past tracing result stored in the tracing result storage unit with a current tracing result so as to detect a difference between the past tracing result and the current tracing result and identify a signal address where the difference between the past tracing result and the current tracing result is detected.

4. The ladder program display device according to claim 3, wherein the tracing result display unit highlights the signal address where the difference is detected, allowing recognition of the signal address where the difference between the past tracing result and the current tracing result is detected.

5. The ladder program display device according to claim 3, wherein the tracing result display unit displays a comparison between the past tracing result and the current tracing result, allowing recognition of the signal address where the difference between the past tracing result and the current tracing result is detected.

6. The ladder program display device according to claim 1, wherein signal addresses to be traced are selectable from the addresses which are set by the tracing target setting unit.
